(19) United States
(12) Patent Application Publication
(10) Pub. No.: US 2026/0211712 A1
(43) Pub. Date: Jul. 23, 2026

(54) AUTOMATED VIRTUAL MACHINE CATEGORIZATION USING ARTIFICIAL INTELLIGENCE TECHNIQUES

(71) Applicant: Dell Products L.P., Round Rock, TX (US)

(72) Inventors: Avinash Kumar, Patna (IN); Bijan Kumar Mohanty, Austin, TX (US); Hung T. Dinh, Austin, TX (US)

(21) Appl. No.: 19/032,307

(22) Filed: Jan. 20, 2025

(51) Int. Cl. G06F 9/455; G06F 11/14

(52) U.S. Cl. CPC G06F 9/45558; G06F 11/1484

(57) ABSTRACT

Methods, apparatus, and processor-readable storage media for automated virtual machine categorization using artificial intelligence techniques are provided herein. An example computer-implemented method includes categorizing one or more virtual machines associated with at least one computing environment by processing performance data corresponding to the one or more virtual machines using at least one neural network; generating at least one explanation of the categorization of the one or more virtual machines by processing one or more outputs of the at least one neural network and context-based information pertaining to the one or more virtual machines using one or more RAG techniques; and performing one or more automated actions related to one or more data backup operations within the at least one computing environment based at least in part on the at least one generated explanation.

### BACKGROUND

In various computing environments including, for example, multi-cloud environments, data protection efforts can present issues related to transparency and accuracy. For instance, conventional data protection techniques often include resource-intensive methods that are not interpretable by end-users, leading to errors and security risks.

### SUMMARY

Illustrative embodiments of the disclosure provide techniques for automated virtual machine categorization using artificial intelligence techniques.

An exemplary computer-implemented method includes categorizing one or more virtual machines associated with at least one computing environment by processing performance data corresponding to the one or more virtual machines using at least one neural network. The method also includes generating at least one explanation of the categorization of the one or more virtual machines by processing one or more outputs of the at least one neural network and context-based information pertaining to the one or more virtual machines using one or more retrieval-augmented generation (RAG) techniques. Further, the method additionally includes performing one or more automated actions related to one or more data backup operations within the at least one computing environment based at least in part on the at least one generated explanation.

Illustrative embodiments can provide significant advantages relative to conventional data protection techniques. For example, problems associated with errors and security risks arising from uninterpretable methods are overcome in one or more embodiments through categorizing virtual machines using at least one neural network and generating processable descriptions of such categorizations using RAG techniques for further use in connection with related data backup operations.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for automated virtual machine categorization using artificial intelligence techniques in an illustrative embodiment.

FIG. 2 shows example system architecture in an illustrative embodiment.

FIG. 3 shows an example data backup workflow in an illustrative embodiment.

FIG. 4 shows an example neural network with multiple outputs in an illustrative embodiment.

FIG. 5 shows an example virtual machine-based (VM-based) RAG engine in an illustrative embodiment.

FIG. 6 is a flow diagram of a process for automated virtual machine categorization using artificial intelligence techniques in an illustrative embodiment.

FIGS. 7 and 8 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

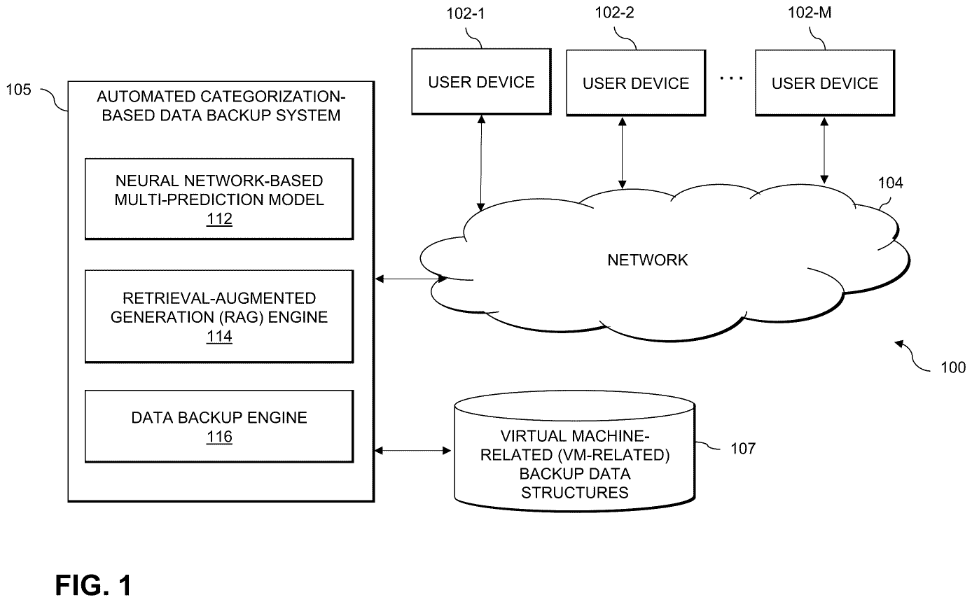

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated categorization-based data backup system 105.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the automated categorization-based data backup system 105 can have one or more VM-related backup data structures 107 configured to store data pertaining to VM categorizations, VM-related criticality scores, VM performance metric data, data backup policy information, etc. The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The VM-related backup data structures 107 in the present embodiment are implemented using one or more storage systems associated with the automated categorization-based data backup system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the automated categorization-based data backup system 105 are one or more input-output devices, which illustratively comprise keyboards, displays or other types of input-output devices in any combination. Such input-output devices can be used, for example, to support one or more user interfaces to the automated categorization-based data backup system 105, as well as to support communication between the automated categorization-based data backup system 105 and other related systems and devices not explicitly shown.

Additionally, the automated categorization-based data backup system 105 in the FIG. 1 embodiment is assumed to be implemented using at least one processing device. Each such processing device generally comprises at least one processor and an associated memory, and implements one or more functional modules for controlling certain features of the automated categorization-based data backup system 105.

More particularly, the automated categorization-based data backup system 105 in this embodiment can comprise a processor coupled to a memory and a network interface.

The processor may comprise, for example, a microprocessor, an application-specific integrated circuit (ASIC), a system-on-chip (SOC), a field-programmable gate array (FPGA), a central processing unit (CPU), a graphics processing unit (GPU), a neural processing unit (NPU), a data processing unit (DPU), a tensor processing unit (TPU), an arithmetic logic unit (ALU), a digital signal processor (DSP), and/or other similar processing device components, as well as other types and arrangements of processing circuitry, in any combination. At least a portion of the functionality of at least one artificial intelligence system and its associated artificial intelligence algorithms provided by one or more processing devices as disclosed herein can be implemented using such circuitry.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the automated categorization-based data backup system 105 to communicate over the network 104 with the user devices 102, and illustratively comprises one or more conventional transceivers.

The automated categorization-based data backup system 105 further comprises a neural network-based multi-prediction model 112, an RAG engine 114, and a data backup engine 116.

As further detailed herein, in at least one embodiment, neural network-based multi-prediction model 112 can be implemented to categorize one or more VMs associated with at least one computing environment by processing performance data corresponding to the one or more virtual machines using at least one neural network. Additionally, RAG engine 114 can be implemented to generate at least one explanation (also referred to herein as an explainable prompt) of the categorization of the one or more virtual machines by processing one or more outputs of the at least one neural network and context-based information pertaining to the one or more virtual machines. Further, in such an embodiment, data backup engine 116 can be implemented to perform one or more automated actions related to one or more data backup operations within the at least one computing environment based at least in part on the at least one generated explanation.

It is to be appreciated that this particular arrangement of elements 112, 114 and 116 illustrated in the automated categorization-based data backup system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for automated virtual machine categorization using artificial intelligence techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of automated categorization-based data backup system 105, VM-related backup data structures 107, and user devices 102 can be on and/or part of the same processing platform.

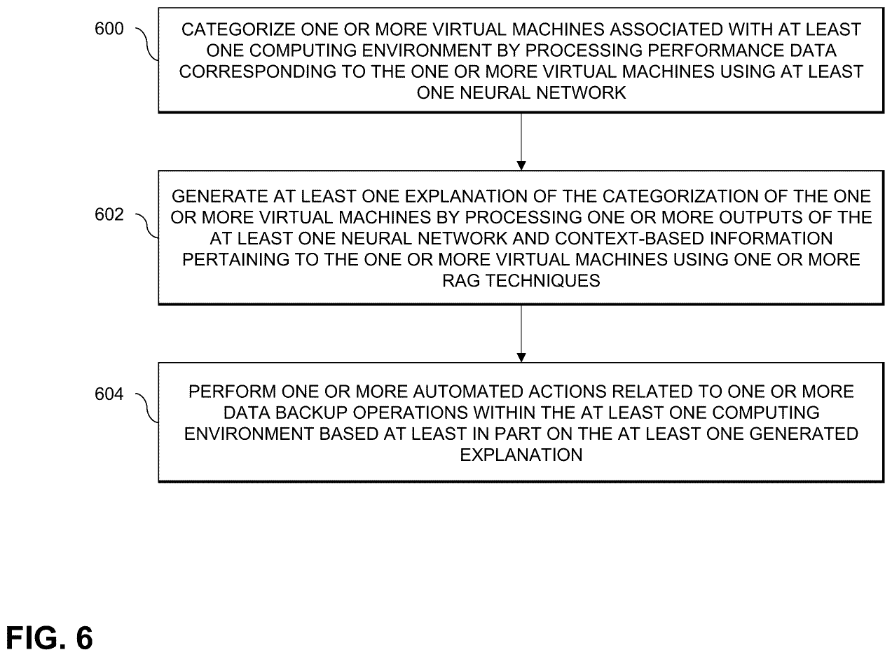

An exemplary process utilizing elements 112, 114 and 116 of an example automated categorization-based data backup system 105 in computer network 100 will be described in more detail with reference to the flow diagram of FIG. 6.

Accordingly, at least one embodiment includes generating and/or implementing an explainable artificial intelligence framework for smart VM categorization and backup prioritization in multi-cloud environments. Such an embodiment can include utilizing RAG techniques to create context-rich, human-readable details for one or more predictions, which can enable and/or facilitate informed decisions by users and/or targeted automated actions by one or more systems related to artificial intelligence-generated classifications. By combining artificial intelligence techniques with explainable (e.g., human-readable) outputs, one or more embodiments include enhancing and/or increasing user trust and facilitating improved resource management across multi-cloud environments.

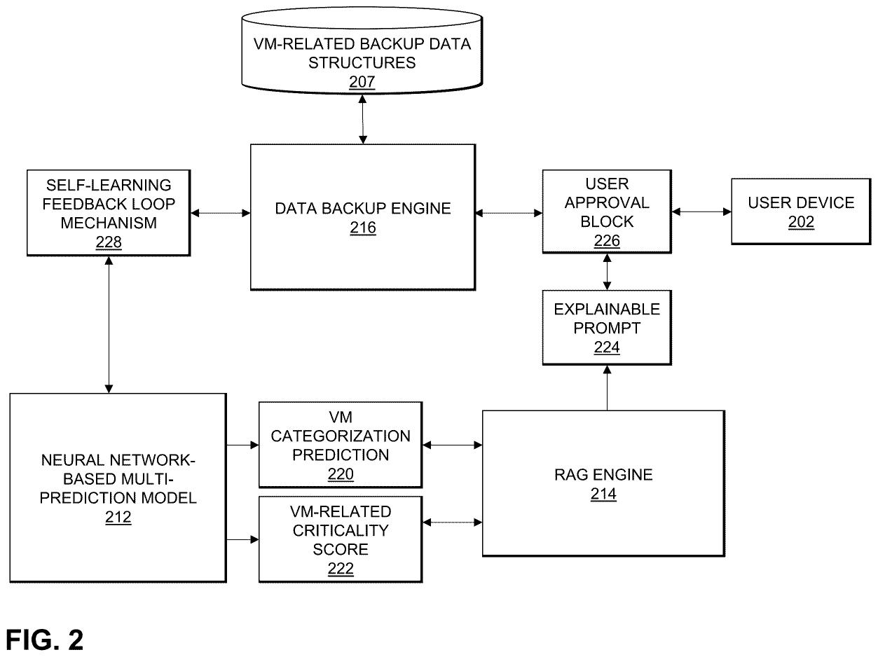

FIG. 2 shows example system architecture in an illustrative embodiment. By way of illustration, FIG. 2 depicts an example embodiment which includes a framework that integrates one or more neural networks, within neural network-based multi-prediction model 212, with explainable artificial intelligence outputs, generated by RAG engine 214, for dynamic VM categorization in multi-cloud environments. More particularly, as depicted in FIG. 2, neural network-based multi-prediction model 212 generates at least one VM categorization prediction 220 and at least one corresponding VM-related criticality score 222 in connection with at least one given VM based at least in part on one or more performance metrics and one or more resource requirements, facilitating the generation of a context-specific explainable prompt 224 for the VM categorization using RAG engine 214.

Also, as depicted in FIG. 2, at least one embodiment includes generating and/or implementing at least one user approval block 226, enabling the user, via user device 202, to approve or reject the VM categorization prediction 220 and/or the VM-related criticality score 222, communicated through the context-specific explainable prompt 224, thereby enhancing user trust and effective resource management. Upon user approval, one or more automated data backup actions are carried out by data backup engine 216 in connection with VM-related backup data structures 207, wherein such automated data backup actions are performed in accordance with the VM categorization prediction 220 and/or the VM-related criticality score 222. Such an embodiment can also include leveraging at least one self-learning feedback loop mechanism 228 that updates the neural network-based multi-prediction model 212 based at least in part on user feedback (e.g., user inputs from the at least one user approval block 226) and/or data derived from the data backup engine 216, dynamically adapting to changing preferences and/or operational conditions.

By way of example and illustration, in multi-cloud environments, VMs can be categorized into categories or tiers to optimize resource allocation and performance. However, conventional systems often lack transparency, making it challenging for users to understand the rationale behind VM category/tier assignments and related policy recommendations.

In one or more embodiments, the categorization of VMs into tiers can be based at least in part on criticality levels derived from various performance and/or operational metrics. Such categories and/or tiers can reflect, for example, the prioritization level(s) (e.g., high priority, medium priority, and/or low priority) assigned to VMs for resource allocation and management. By way merely of illustration, a high priority categorization can be indicative of high CPU and memory usage, low latency and high uptime requirements, as well as high service level agreement (SLA) compliance and business impact scores. Additionally, a medium priority categorization can be indicative of moderate CPU and memory usage, medium latency tolerance and uptime requirements, as well as medium SLA compliance and business impact scores. Further, a low priority categorization can be indicative of low CPU and memory usage, higher latency tolerance and lower uptime requirements, as well as lower SLA compliance and business impact scores. In at least one embodiment, such criticality levels can be determined by normalizing and scoring the relevant metrics, facilitating a data-driven and transparent categorization process aligned with operational needs.

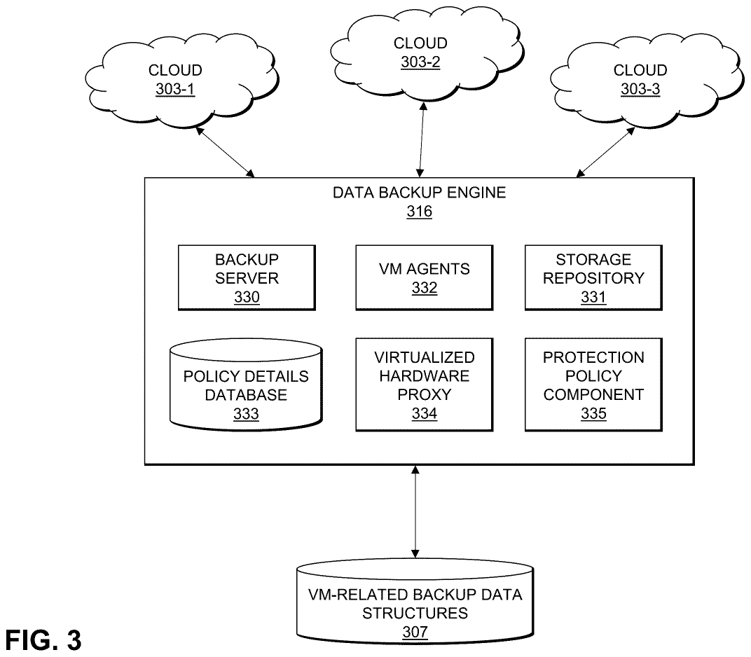

FIG. 3 shows an example data backup workflow in an illustrative embodiment. By way of illustration, FIG. 3 depicts data backup engine 316 and VM-related backup data structures 307 within a multi-cloud environment which includes cloud 303-1, cloud 303-2 and cloud 303-3. More particularly, data backup engine 316 includes a backup server 330, VM agents 332, a storage repository 331, a policy details database 333, virtualized hardware proxy 334, and protection policy component 335. Further, in one or more embodiments, each is assigned a backup policy (e.g., backup frequency, backup priority, and backup retention period), which is stored in the policy details database 333. This can, for example, ensure that backup operations align with the organization's data protection requirements.

Also, in such an embodiment, with respect to backup initialization, the backup server 330 coordinates a backup process by identifying the VMs requiring backup based on the backup schedule and policies stored in the policy details database 333. VM agents 332, which can be installed on and/or connected to VMs, gather backup data (e.g., VM images, metadata, critical files, etc.) and ensure that such data is prepared in a format compatible with the backup system. The backup server 330 receives at least a portion of the data collected by the VM agents 332 and transfers such data to the storage repository 331, which can serve as a central location where backup data is securely stored. The storage repository 331 manages and organizes the backed-up data, ensuring efficient storage utilization and facilitating retrieval for restore operations when needed. Additionally, in a multi-cloud environment, the data backup engine 316 can adapt to the specific configurations of different cloud providers. In such an embodiment, the backup server 330 acts as the orchestrator, ensuring data consistency and compliance with the assigned backup policies across clouds.

As further detailed herein, one or more embodiments include processing historical VM performance data related to multi-cloud deployments and integrating at least one RAG engine with at least one neural network model to analyze and explain VM categorizations. Such an embodiment can include implementing one or more neural networks with multi-outputs. Such a neural network can include using one or more shared hidden layers to learn one or more common features from input data, followed by one or more separate output layers for each designated task. Such an architecture enables multiple simultaneous predictions, such as, for example, category classification and criticality scoring, by leveraging shared knowledge while specializing in distinct outputs. This multi-target approach enhances efficiency and accuracy in predictive modeling.

Also, in at least one embodiment, at least one RAG engine enhances the interpretability of VM categorizations by combining information retrieval with generative capabilities. In such an embodiment, the at least one RAG engine retrieves contextual information from one or more textual data sources and generates detailed explanations that support VM criticality scores and category assignments. As used herein, a criticality score is used to quantify the importance of a VM based at least in part on the VM's performance metric(s). Also, in one or more embodiments, the criticality scores are used in one or more backup processes, including, e.g., guiding which VMs should be prioritized for backup based at least in part on VM urgency and/or VM importance, as determined by one or more supervised learning models (e.g., at least one random forest model, at least one gradient boosting machine, at least one neural network, etc.).

Additionally, in at least one embodiment, at least one vector data structure can be used to efficiently store and query high-dimensional embeddings of textual data. Such embeddings enable fast and accurate retrieval of relevant information from data sources such as, e.g., administrator guides knowledge base articles (KBAs), etc., which an RAG engine can use to provide one or more contextual explanations. Further, in one or more embodiments, an embedding model converts textual data (e.g., from documents) into high-dimensional vectors, capturing the semantic content of the text. This allows an RAG engine to perform effective similarity searches and retrieve pertinent information to explain VM categorizations and information related thereto (e.g., VM criticality, etc.).

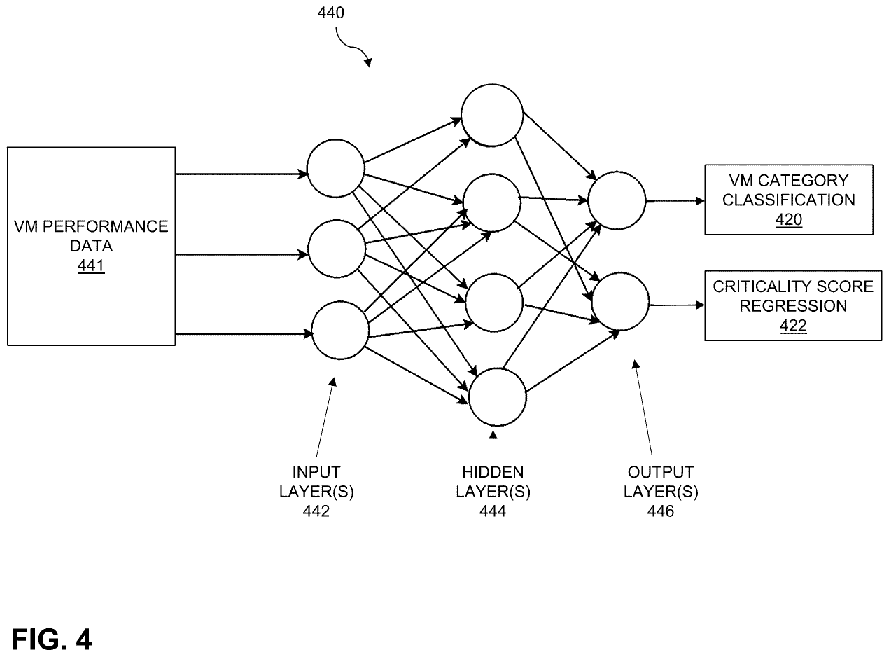

FIG. 4 shows an example neural network with multiple outputs in an illustrative embodiment. By way of illustration, FIG. 4 depicts neural network 440, trained on historical VM performance data and designed and/or configured (as part of neural network-based multi-prediction model 112 and/or neural network-based multi-prediction model 212) with one or more input layers 442, one or more shared hidden layers 444 and one or more separate output layers 446 for each of multiple prediction tasks. In such an embodiment, the one or more input layers 442 can be associated with VM performance data 441, including metrics such as CPU usage, memory utilization, disk input/output (I/O), etc. The shared hidden layers 444 can include, for example, multiple dense (fully connected) layers, each applying one or more linear transformations followed by one or more non-linear activation functions (such as, e.g., rectified linear unit (ReLU)). These layers will learn and extract one or more common features from the input data, capturing one or more patterns and/or interactions among the various performance metrics.

The neural network 440 can then be branched into one or more output layers 446 for each of one or more prediction tasks. In an example embodiment, the neural network 440 can be configured for one task of generating a VM category classification 420 and one task of generating a criticality score regression 422. In such an embodiment, the category classification branch can include one or more additional dense layers ending with a softmax activation function to output one or more probabilities for each VM category. The criticality score regression branch can have its own dense layers, concluding with a linear activation function to predict a criticality score as a continuous value. Such a neural network architecture allows the shared hidden layers 444 to leverage one or more common patterns in the data, while the separate output layers 446 specialize in their respective tasks. This multi-target approach enables efficient and simultaneous predictions for both VM categorization and criticality scoring, enhancing prioritization based at least in part on predicted importance.

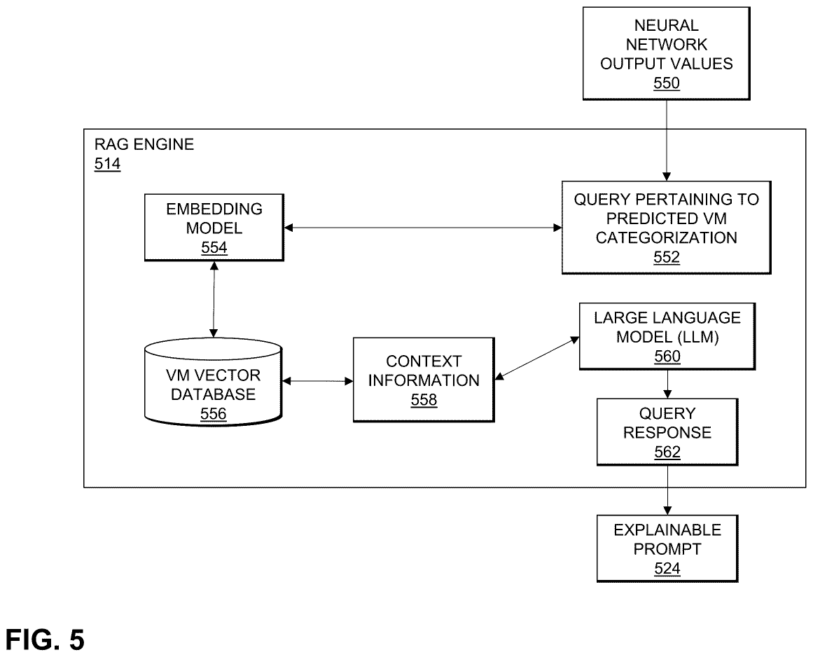

FIG. 5 shows an example VM-based RAG engine in an illustrative embodiment. By way of illustration, FIG. 5 depicts RAG engine 514, which is configured and/or implemented to enhance the interpretability of VM categorizations by combining information retrieval with generative capabilities. More particularly, RAG engine 514 utilizes a dual-component approach which includes a retriever and a generator. The retriever, which can include embedding model 554, can generate and/or process a query, generated based at least in part on neural network output values 550, pertaining to the predicted VM categorization 552 and query a VM vector database 556 containing textual data (e.g., derived from administrator guides, KBAs, etc.) to fetch contextually relevant information 558. Such actions can include leveraging techniques such as dense vector embedding and similarity searching to identify one or more relevant contextual information related to the predicted VM categorization.

In at least one embodiment, VM vector database 556 is implemented to store high-dimensional embeddings of textual data from various sources (e.g., administrator guides which provide operational and configuration information, troubleshooting guides, software release notes, issue tracking software outputs, KBAs containing troubleshooting and best practices information, technical documentation including detailed technical specifications and usage instructions, performance logs, incident reports documenting issues and resolutions, SLAs defining expected service performance and commitments, etc.). Such data sources can provide contextual information to be utilized and/or processed by the RAG engine 514 to generate an explainable prompt 524 for each VM categorization.

As noted, once contextually relevant information 558 is retrieved, a generator component, which can include at least one large language model (LLM) 560, can use at least a portion of the contextual information to produce a response 562 to the query pertaining to the predicted VM categorization 552. In one or more embodiments, producing such a response 562 can include applying one or more natural language generation techniques to synthesize the information into readable text. The RAG engine 514 can ensure that each VM categorization is supported by contextual evidence, rendering VM predictions transparent and understandable. By integrating the RAG engine 514, at least one embodiment includes providing users with contextually based explanations that align with documented knowledge, enhancing the credibility and usability of VM categorization results.

As also depicted in FIG. 5, an explainable prompt 524 can be generated and output by RAG engine 514 which integrates the response 562 with information pertaining to the corresponding VM criticality score(s). Accordingly, in such an embodiment, the RAG engine 514 generates and/or provides contextual information and explanations based at least in part on textual data retrieved from various sources, and at least a portion of this contextual information is then combined with the corresponding VM criticality score and category assignment to generate and output (to a user device and/or user approval block) explainable prompt 524.

Additionally, as noted, an explainable prompt can utilize this combined information to generate a detailed, transparent explanation for each VM categorization. In one or more embodiments, generating such explanations can include using, for example, one or more Shapley values, one or more local interpretable model-agnostic explanations (LIME), etc., to further clarify how each of one or more features contributed to the VM criticality score. Also, such an explanation will integrate the RAG-provided context with the computed criticality score and category assignment to provide a comprehensive, understandable rationale for the VM category assignment.

As used herein, features contributing to a VM criticality score can refer to measurable attributes and/or metrics of a VM that are used to assess performance, resource requirements, prioritization, etc. By way merely of illustration, example features can include performance metrics such as CPU usage, memory utilization, disk I/O, network throughput, etc., operational metrics such as uptime, patch level, service availability, response time, latency, etc., resource allocation trends such as historical trends in resource consumption, load average, incident history, etc., business impact metrics such as SLA compliance, business criticality, incident resolution times, etc., and security and access control attributes such as firewall rules, access permissions, and/or other security-related configurations.

Referring again to FIG. 2, one or more embodiments include enhancing one or more backup processes by integrating VM categorization and contextual explanations into resource allocation. In such an embodiment, data backup engine 216 (which can include, for example, a backup server) can use VM-related criticality score 222 and VM categorization prediction 220, derived from context-specific explainable prompt 224, to prioritize one or more backup operations. For example, high-priority VMs can receive resources first, ensuring timely backups. Also, the RAG engine-generated context-specific explainable prompt 224 can be utilized to help administrators understand the prioritization rationale, improving decision-making.

Additionally, one or more embodiments can also include implementing at least one self-learning feedback loop mechanism 228 wherein the system continuously learns from user feedback and/or results from the one or more backup operations. For example, as users approve or modify VM categorizations, such feedback is used to update, using self-learning feedback loop mechanism 228, the neural network-based multi-prediction model 212 in real time. This self-learning capability ensures that the system dynamically adapts to one or more changing user preferences and/or one or more changing operational conditions, improving the accuracy and relevance of VM categorizations over time.

FIG. 6 is a flow diagram of a process for automated virtual machine categorization using artificial intelligence techniques in an illustrative embodiment. It is to be understood that this particular process is only an example, and additional or alternative processes can be carried out in other embodiments.

In this embodiment, the process includes steps 600 through 604. These steps are assumed to be performed by the automated categorization-based data backup system 105 utilizing elements 112, 114 and 116.

Step 600 includes categorizing one or more virtual machines associated with at least one computing environment by processing performance data corresponding to the one or more virtual machines using at least one neural network. In at least one embodiment, categorizing one or more virtual machines associated with at least one computing environment includes processing performance data corresponding to the one or more virtual machines using at least one neural network comprising one or more input layers associated with one or more types of performance data, one or more hidden layers applying one or more linear transformations and one or more non-linear activation functions, and one or more output layers designated for one or more respective prediction tasks. Also, in at least one embodiment, the at least one computing environment can include a multi-cloud environment comprising multiple virtual machines.

Step 602 includes generating at least one explanation of the categorization of the one or more virtual machines by processing one or more outputs of the at least one neural network and context-based information pertaining to the one or more virtual machines using one or more RAG techniques. In one or more embodiments, generating at least one explanation of the categorization of the one or more virtual machines includes processing one or more outputs of the at least one neural network comprising the categorization of the one or more virtual machines and at least one criticality score attributed to the categorization. Also, in at least one embodiment, processing one or more outputs of the at least one neural network and context-based information pertaining to the one or more virtual machines using one or more RAG techniques can include implementing at least one embedding model to convert text data from at least one of the one or more outputs of the at least one neural network and the context-based information into one or more vectors capturing one or more portions of semantic content of the text data.

Additionally or alternatively, generating at least one explanation of the categorization of the one or more virtual machines can include processing the context-based information pertaining to the one or more virtual machines, obtained using one or more retrieval techniques, and the one or more outputs of the at least one neural network using at least one LLM.

Step 604 includes performing one or more automated actions related to one or more data backup operations within the at least one computing environment based at least in part on the at least one generated explanation. In at least one embodiment, performing one or more automated actions related to one or more data backup operations includes automatically prioritizing execution of the one or more data backup operations within the at least one computing environment in accordance with the at least one generated explanation. Also, in one or more embodiments, performing one or more automated actions related to one or more data backup operations can include automatically initiating a backup of at least a portion of data associated with at least one of the one or more virtual machines in accordance with the at least one generated explanation of the categorization of the one or more virtual machines.

Additionally or alternatively, performing one or more automated actions related to one or more data backup operations can include automatically outputting, to at least one user device, the at least one generated explanation and a corresponding request for approval of at least one of the one or more data backup operations. Further, in at least one embodiment, performing one or more automated actions related to one or more data backup operations can include automatically training at least a portion of the at least one neural network based at least in part on feedback to the at least one generated explanation.

Accordingly, the particular processing operations and other functionality described in conjunction with the flow diagram of FIG. 6 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to categorize virtual machines using at least one neural network and generate processable descriptions of such categorizations using RAG techniques for further use in connection with related data backup operations. These and other embodiments can effectively overcome problems associated with errors and security risks arising from uninterpretable methods.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

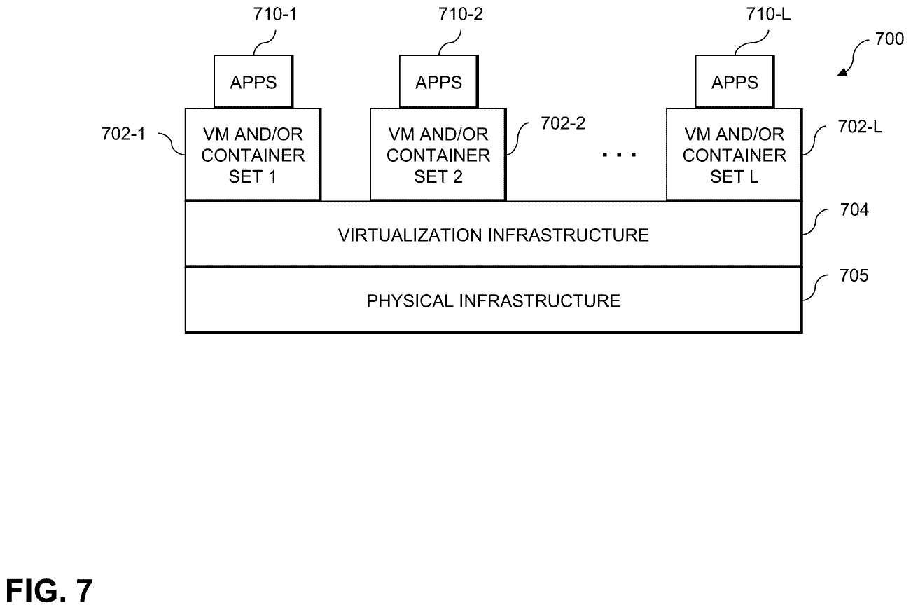

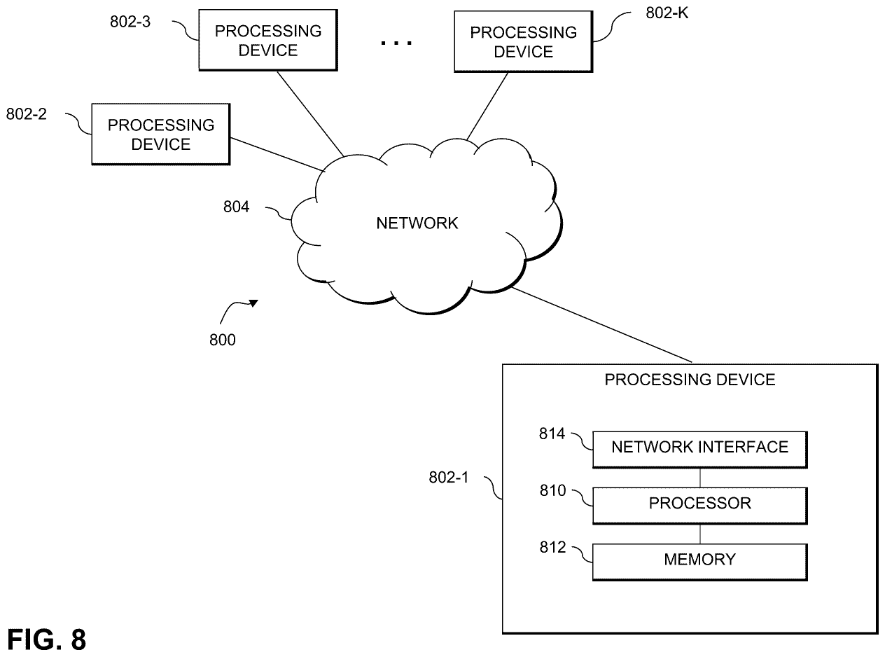

Illustrative embodiments of processing platforms will now be described in greater detail with reference to FIGS. 7 and 8. Although described in the context of system 100, these platforms may also be used to implement at least portions of other information processing systems in other embodiments.

FIG. 7 shows an example processing platform comprising cloud infrastructure 700. The cloud infrastructure 700 comprises a combination of physical and virtual processing resources that are utilized to implement at least a portion of the information processing system 100. The cloud infrastructure 700 comprises multiple VMs and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 comprise respective VMs, respective sets of one or more containers, or respective sets of one or more containers running in VMs. In some implementations of the FIG. 7 embodiment, the VMs/container sets 702 comprise respective VMs implemented using virtualization infrastructure 704 that comprises at least one hypervisor.

A hypervisor platform may be used to implement a hypervisor within the virtualization infrastructure 704, wherein the hypervisor platform has an associated virtual infrastructure management system. The underlying physical machines comprise one or more information processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises a portion of system 100 and includes a plurality of processing devices, denoted 802-1, 802-2, 802-3, . . . 802-K, which communicate with one another over a network 804.

The network 804 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 802-1 in the processing platform 800 comprises a processor 810 coupled to a memory 812.

The processor 810 comprises a microprocessor, an ASIC, an SOC, an FPGA, a CPU, a GPU, an NPU, a DPU, a TPU, an ALU, a DSP, and/or other similar processing device components, as well as other types and arrangements of processing circuitry, in any combination. At least a portion of the functionality of at least one artificial intelligence system and its associated artificial intelligence algorithms provided by one or more processing devices as disclosed herein can be implemented using such circuitry.

The memory 812 comprises RAM, ROM or other types of memory, in any combination. The memory 812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
categorizing one or more virtual machines associated with at least one computing environment by processing performance data corresponding to the one or more virtual machines using at least one neural network;
generating at least one explanation of the categorization of the one or more virtual machines by processing one or more outputs of the at least one neural network and context-based information pertaining to the one or more virtual machines using one or more retrieval-augmented generation (RAG) techniques; and
performing one or more automated actions related to one or more data backup operations within the at least one computing environment based at least in part on the at least one generated explanation;
wherein the method is performed by at least one processing device comprising a processor coupled to a memory.

2. The computer-implemented method of claim 1, wherein generating at least one explanation of the categorization of the one or more virtual machines comprises processing one or more outputs of the at least one neural network comprising the categorization of the one or more virtual machines and at least one criticality score attributed to the categorization.

3. The computer-implemented method of claim 1, wherein processing one or more outputs of the at least one neural network and context-based information pertaining to the one or more virtual machines using one or more RAG techniques comprises implementing at least one embedding model to convert text data from at least one of the one or more outputs of the at least one neural network and the context-based information into one or more vectors capturing one or more portions of semantic content of the text data.

4. The computer-implemented method of claim 1, wherein performing one or more automated actions related to one or more data backup operations comprises automatically prioritizing execution of the one or more data backup operations within the at least one computing environment in accordance with the at least one generated explanation.

5. The computer-implemented method of claim 1, wherein performing one or more automated actions related to one or more data backup operations comprises automatically initiating a backup of at least a portion of data associated with at least one of the one or more virtual machines in accordance with the at least one generated explanation of the categorization of the one or more virtual machines.

6. The computer-implemented method of claim 1, wherein generating at least one explanation of the categorization of the one or more virtual machines comprises processing the context-based information pertaining to the one or more virtual machines, obtained using one or more retrieval techniques, and the one or more outputs of the at least one neural network using at least one large language model (LLM).

7. The computer-implemented method of claim 1, wherein categorizing one or more virtual machines associated with at least one computing environment comprises processing performance data corresponding to the one or more virtual machines using at least one neural network comprising one or more input layers associated with one or more types of performance data, one or more hidden layers applying one or more linear transformations and one or more non-linear activation functions, and one or more output layers designated for one or more respective prediction tasks.

8. The computer-implemented method of claim 1, wherein performing one or more automated actions related to one or more data backup operations comprises automatically outputting, to at least one user device, the at least one generated explanation and a corresponding request for approval of at least one of the one or more data backup operations.

9. The computer-implemented method of claim 1, wherein performing one or more automated actions related to one or more data backup operations comprises automatically training at least a portion of the at least one neural network based at least in part on feedback to the at least one generated explanation.

10. The computer-implemented method of claim 1, wherein the at least one computing environment comprises a multi-cloud environment comprising multiple virtual machines.

11. A non-transitory processor-readable storage medium having stored therein program code of one or more software programs, wherein the program code when executed by at least one processing device causes the at least one processing device:
to categorize one or more virtual machines associated with at least one computing environment by processing performance data corresponding to the one or more virtual machines using at least one neural network;
to generate at least one explanation of the categorization of the one or more virtual machines by processing one or more outputs of the at least one neural network and context-based information pertaining to the one or more virtual machines using one or more retrieval-augmented generation (RAG) techniques; and
to perform one or more automated actions related to one or more data backup operations within the at least one computing environment based at least in part on the at least one generated explanation.

12. The non-transitory processor-readable storage medium of claim 11, wherein generating at least one explanation of the categorization of the one or more virtual machines comprises processing one or more outputs of the at least one neural network comprising the categorization of the one or more virtual machines and at least one criticality score attributed to the categorization.

13. The non-transitory processor-readable storage medium of claim 11, wherein processing one or more outputs of the at least one neural network and context-based information pertaining to the one or more virtual machines using one or more RAG techniques comprises implementing at least one embedding model to convert text data from at least one of the one or more outputs of the at least one neural network and the context-based information into one or more vectors capturing one or more portions of semantic content of the text data.

14. The non-transitory processor-readable storage medium of claim 11, wherein performing one or more automated actions related to one or more data backup operations comprises automatically prioritizing execution of the one or more data backup operations within the at least one computing environment in accordance with the at least one generated explanation.

15. The non-transitory processor-readable storage medium of claim 11, wherein performing one or more automated actions related to one or more data backup operations comprises automatically initiating a backup of at least a portion of data associated with at least one of the one or more virtual machines in accordance with the at least one generated explanation of the categorization of the one or more virtual machines.

16. An apparatus comprising:
at least one processing device comprising a processor coupled to a memory;
the at least one processing device being configured:
to categorize one or more virtual machines associated with at least one computing environment by processing performance data corresponding to the one or more virtual machines using at least one neural network;
to generate at least one explanation of the categorization of the one or more virtual machines by processing one or more outputs of the at least one neural network and context-based information pertaining to the one or more virtual machines using one or more retrieval-augmented generation (RAG) techniques; and
to perform one or more automated actions related to one or more data backup operations within the at least one computing environment based at least in part on the at least one generated explanation.

17. The apparatus of claim 16, wherein generating at least one explanation of the categorization of the one or more virtual machines comprises processing one or more outputs of the at least one neural network comprising the categorization of the one or more virtual machines and at least one criticality score attributed to the categorization.

18. The apparatus of claim 16, wherein processing one or more outputs of the at least one neural network and context-based information pertaining to the one or more virtual machines using one or more RAG techniques comprises implementing at least one embedding model to convert text data from at least one of the one or more outputs of the at least one neural network and the context-based information into one or more vectors capturing one or more portions of semantic content of the text data.

19. The apparatus of claim 16, wherein performing one or more automated actions related to one or more data backup operations comprises automatically prioritizing execution of the one or more data backup operations within the at least one computing environment in accordance with the at least one generated explanation.

20. The apparatus of claim 16, wherein performing one or more automated actions related to one or more data backup operations comprises automatically initiating a backup of at least a portion of data associated with at least one of the one or more virtual machines in accordance with the at least one generated explanation of the categorization of the one or more virtual machines.
